(19) United States
(12) Patent Application Publication
(10) Pub. No.: US 2011/0167047 A1
(43) Pub. Date: Jul. 7, 2011

(54) EDITING APPARATUS, METHOD, AND STORAGE MEDIUM

(75) Inventor: Akira ARATA, Fukuoka-shi (JP)

(73) Assignee: FUJITSU LIMITED, Kawasaki-shi (JP)

(21) Appl. No.: 12/976,999

(22) Filed: Dec. 22, 2010

(30) Foreign Application Priority Data
Jan. 6, 2010 (JP) 2010-1580

(51) Int. Cl. G06F 17/00; G06F 17/30

(52) U.S. Cl. 707/684; 707/E17.001

(57) ABSTRACT

An editing apparatus includes: a storage unit to store, as execution information in a time-series order of edit or undo process, an edit content indicating a content of edit of data and an undo content indicating a content of undo of the data; an edit executor to edit the data and to store on the storage unit the edit content as the execution information; and an undo executor to undo the data to a state prior to the execution of the edit content if the updated execution information stored on the storage unit indicates the edit content, or to undo the data to a state prior to the execution of the undo content if the updated execution information stored on the storage unit indicates the undo content, and to store as the execution information a content of the executed undo on the memory unit.

### CROSS-REFERENCE TO RELATED APPLICATIONS

This application is based upon and claims the benefit of priority of the prior Japanese Patent Application No. 2010-001580, filed on Jan. 6, 2010, the entire contents of which are incorporated herein by reference.

### FIELD

Various embodiments described herein relate to an editing method, a storage medium storing edited data, and an editing apparatus.

### BACKGROUND

If an electrical computer aided design (CAD) software application is used for electrical wiring, editing is performed on a per net unit basis, with each net unit indicating a wiring connection from one pin on one electrical part to another pin on the same or a second electrical part. The pins include not only a pin of an electrical part, but also a plated hole that connects one wiring layer to another.

In the editing of the wiring design by the electrical CAD, a variety of wiring paths are typically studied from the standpoint of noise and wiring routing. To undo an editing process of a wiring under study to an original state at a given time point, undo processes such as processing “undo” immediately after processing “edit”, and the like are typically used. As used herein, an “undo process” refers to a command in a computer program to undoing the immediately preceding process.

However, a technique of restoring an edited content using the undo process during an editing process is not only limited within the electrical CAD software application, but also in a variety of applications including document production software and spreadsheet software. Japanese Laid-Open Patent Publication No. 63-211467 discusses such a technique.

### SUMMARY

According to an aspect of the invention, an editing apparatus includes: a storage unit to store, as execution information in a time-series order of edit or undo processes, an edit content indicating a content of edit of data and an undo content indicating a content of undo of the data; an edit executor to edit the data and to store on the storage unit the edit content as the execution information; and an undo executor to undo the data to a state prior to the execution of the edit content if the updated execution information stored on the storage unit indicates the edit content, or to undo the data to a state prior to the execution of the undo content if the updated execution information stored on the storage unit indicates the undo content, and to store as the execution information a content of the executed undo on the memory unit.

The object and advantages of the invention will be realized and attained by at least the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a functional block diagram illustrating an editing apparatus of a first embodiment;

FIG. 2 illustrates an example of an executed editing process;

FIG. 3 illustrates an example of information stored on a storage unit;

FIG. 4 illustrates a newly executed undo process;

FIG. 5 illustrates information on the storage unit modified in response to an executed undo process;

FIG. 6 illustrates a process example in which an executed undo process is stored as redo information on the storage unit;

FIG. 7 is a flowchart illustrating a process flow of the editing apparatus of the first embodiment;

FIG. 8 is a flowchart illustrating a process flow of the undo process;

FIG. 9 illustrates a history example of edit information of an executed edit process;

FIG. 10 illustrates a process example in which an executed undo content is stored as redo information;

FIG. 11 illustrates an edit process that resumes after the undo process;

FIG. 12 illustrates a process example in which an undo process is executed subsequent to the resumption of the edit process of FIG. 11;

FIG. 13 illustrates an example of an electrical wiring board as an edit target;

FIG. 14 illustrates a process example in which the wiring design of active parts A and B (net A) on the electrical wiring board of FIG. 13 is edited;

FIG. 15 illustrates a process example in which the wiring design of the active parts A and B (net B) on the electrical wiring board of FIG. 14 is edited;

FIG. 16 illustrates a process example in which the wiring design of active parts C and D (net C) on the electrical wiring board of FIG. 15 is edited;

FIG. 17 illustrates a process example in which an undo process is executed on the net A on the electrical wiring board of FIG. 16;

FIG. 18 illustrates a process example in which a second undo cycle is executed on the net A on the electrical wiring board of FIG. 17;

FIG. 19 illustrates a process example in which the edit process resumes on the electrical wiring board of FIG. 18 to edit the wiring between the active parts A and B (net A);

FIG. 20 illustrates a process example in which an undo process is executed on the net A on the electrical wiring board of FIG. 19;

FIG. 21 illustrates a process example in which a second undo cycle is executed on the net A on the electrical wiring board of FIG. 20;

FIG. 22 illustrates a process example in which a third undo cycle is executed on the net A on the electrical wiring board of FIG. 21;

FIG. 23 illustrates a computer system executing a data editing program; and

FIG. 24 illustrates a related art technique.

### DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures. In the figures, dimensions and/or proportions may be exaggerated for clarity of illustration. It will also be understood that when an element is referred to as being “connected to” another element, it may be directly connected or indirectly connected, i.e., intervening elements may also be present. Further, it will be understood that when an element is referred to as being “between” two elements, it may be the only element between the two elements, or one or more intervening elements may also be present.

According to related art, it is difficult to set data back to a state prior to being undone if an edit process resumes once the data under edit is undone at any time point.

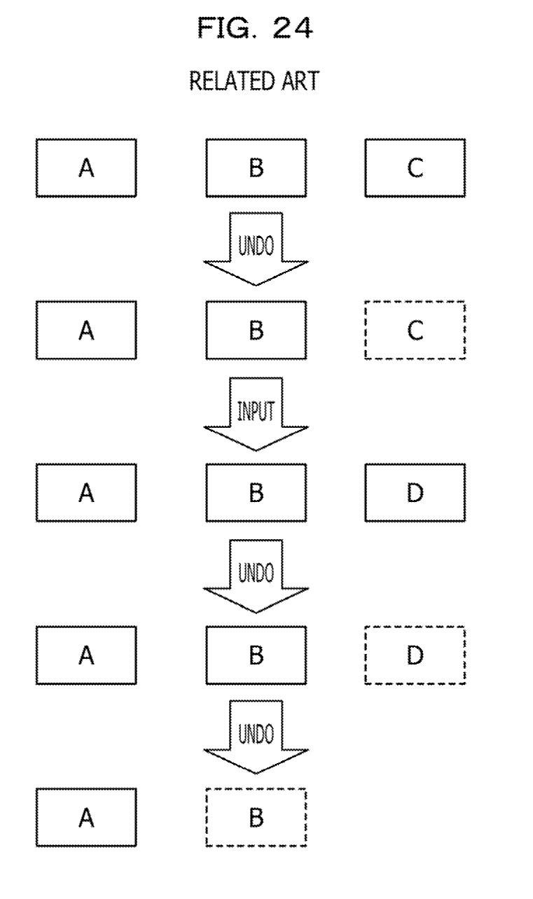

The problem of related art is discussed with reference to document production software illustrated in FIG. 24. FIG. 24 illustrates a related art technique. An apparatus (hereinafter referred to as a text input apparatus) executing a document production software program receives an input from a user and enters letters “A,” “B,” and “C” in that order on specific regions thereof. Upon receiving an undo operation input from the user, the text input apparatus deletes the letter “C.” The text input apparatus receives again an edit operation input from the user, and inputs a received letter “D” in succession to “A” and “B.” In this way, “A,” “B,” and “D” are input in that order.

Upon receiving an undo process input from the user, the text input apparatus deletes the last input letter “D.” If another undo process input is received from the user, the text input apparatus deletes “B” input before “D” that was deleted in response to the preceding undo process.

If the edit process resumes once “C” is deleted in response to the first undo operation, the text input apparatus has difficulty restoring “A,” “B,” and “C” as a state preceding the resumption of data edit. That is, in the series of editing and undo processes illustrated in FIG. 24, it is difficult to restore the deleted letter “C” using the undo process.

An editing method, a recording medium storing an editing program, and an editing apparatus are described in detail below. The embodiments discussed below are not intended to limit the scope of the invention.

Structure of Editing Apparatus

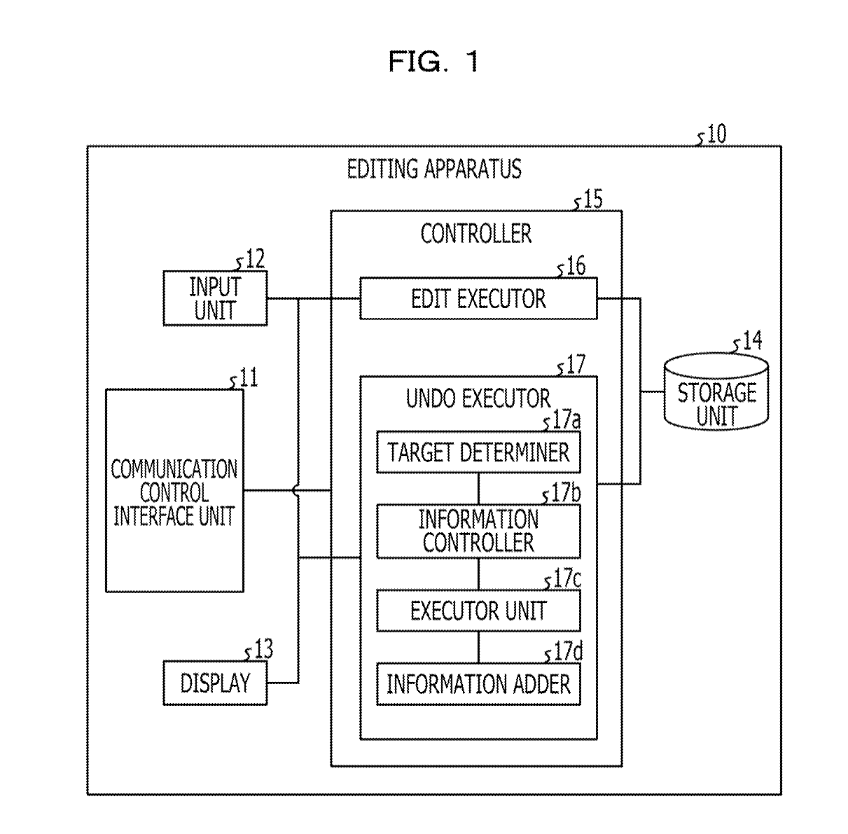

FIG. 1 is a block diagram illustrating an editing apparatus 10 of a first embodiment. The editing apparatus 10 of FIG. 1 processes a variety of data including computer aided design (CAD) data for electrical wiring boards, parts, and wirings, and data for document input software and spreadsheet software. The editing apparatus 10 also performs data editing for updating and undoing data. According to the first embodiment, the editing apparatus 10 is applied to an electrical CAD apparatus processing CAD data. The editing apparatus 10 may be included in a computer system executing a software program for document input and spreadsheet calculation.

As illustrated in FIG. 1, the editing apparatus 10 includes communication control interface unit 11, input unit 12, display 13, storage unit 14, and controller 15. The communication control interface unit 11 includes at least one communication port, and controls information exchanged with another apparatus. For example, the communication control interface unit 11 receives data as a data edit target, and then transfers the received data to the controller 15.

The input unit 12 may include a keyboard, a mouse, and a microphone. The input unit 12 receives an edit start instruction, an edit end instruction, an undo operation input, and the like, and then inputs the received instructions to the controller 15 or the like. The input unit 12 reads information from and writes information to a storage medium such as a compact disc (CD), a digital versatile disc (DVD), or a magnetic disc. For example, the input unit 12 reads a file as a data edit target from the storage medium, and then transfers the read file to the controller 15.

The display 13 may include one of a monitor, a display, a touchpanel, and a loudspeaker. The display unit outputs and displays data edit results provided by the controller 15 or data under edit. The display 13 cooperating with the input unit 12 has a pointing device function.

The storage unit 14 may include one of a semiconductor memory such as a random access memory (RAM) and a storage device such as an optical disc. The storage unit 14 stores data and programs, which the controller 15 uses in the execution of a variety of processes. If the controller 15 performs a storage request on data under data edit, the storage unit 14 stores the data.

The storage unit 14, as a storage area, stores undo information in a time-series order of edit or undo processes. The undo information includes an edit content indicating a content of an edit process performed on data and an undo content indicating a content of an undo process performed on the data. The storage unit 14 may further map to the undo information an indication of an edit location where an edit operation or an undo operation is performed, such as a net A or a part A in the electrical CAD.

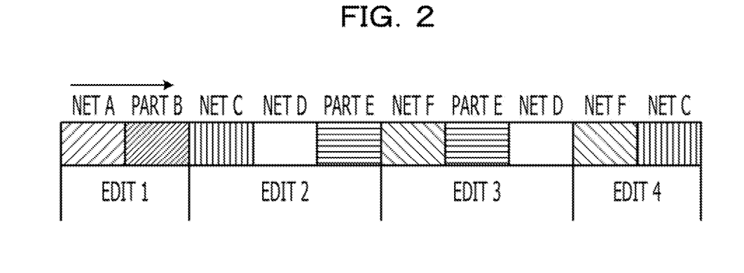

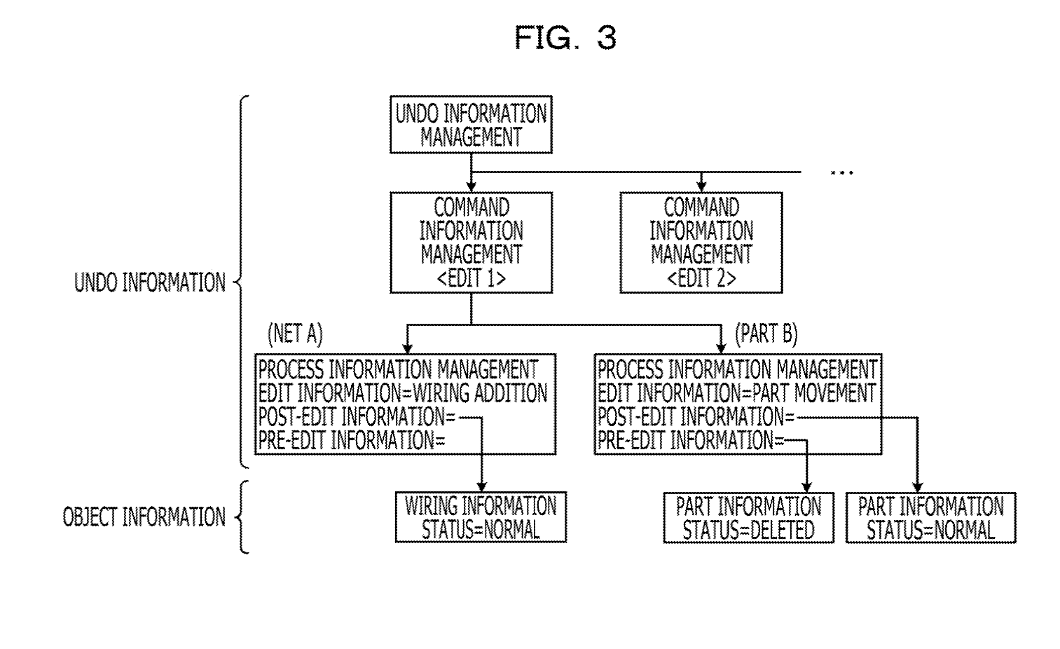

Referring to FIGS. 2 and 3, an example of information stored on the storage unit 14 is discussed. FIG. 2 illustrates an example of an executed edit process, and FIG. 3 illustrates an example of information stored on the storage unit 14. The information illustrated in FIG. 3 is stored when the edit process of FIG. 2 is performed. In the discussion here, arrangement of wiring and parts is modified on the electrical CAD in a data edit process. For example, a data edit process is performed on a per net unit basis with each net unit indicating a connection of wiring from one pin on one electrical part to another pin on the same or second electrical part.

More specifically, edit 1, edit 2, edit 3, and edit 4 are performed in that order on the CAD data as an edit target. In the edit 1, a net A is edited and a part B is edited. Similarly, in the edit 2, a net C is edited, a net D is edited, and a part E is edited. In the edit 3, a net F is edited, the part E is edited, and the net D is edited. In the edit 4, the net F is edited and the net C is edited.

If the data edit process is performed in this way, the storage unit 14 stores “undo information” and “object information” in a mapped state as information to be used to reverse the executed process as diagrammatically illustrated in FIG. 3. The “undo information” includes “command information management” and “process information management” as a management unit. The undo information thus serves as a management unit for managing all contents of data edit to one data file. More specifically, the storage unit 14 stores one file of CAD data by one piece of “undo information.”

The “command information management” is used to manage a single piece of execution information, and for example, includes a data edit content of each of the edit 1 through the edit 4. A data edit content may includes, for example, a type information (e.g. adding, deleting, editing, restoring(undoing)), information of which part of the data is edited, the data before and after edited. The “process information management” is used to manage a process organizing the execution information stored at the command information management. The process information management includes “edit information” indicating an edit content, and “object information” that has changed in response to the execution of a process, namely, “object information” prior to and subsequent to the execution of a process. The “edit information” includes edit details such as addition of wiring, and movement of a part. The “object information” includes a “status” indicating whether a wiring added in the wiring addition is a target to be displayed on the display 13 if the wiring addition is performed as the “edit information.” The “status” is “normal” if data is displayed on the display 13 and is “deleted” if the data is not displayed on the display 13. An actually executed process content, such as the direction and distance of movement of the part B, and a modification to the wiring between the part A and the part B, may be stored with the “command information management” mapped thereto, or may be stored on another database.

Referring to FIG. 3, the storage unit 14 stores the edit 1 as the “command information management” and “edit information=wiring addition” related to the net A in the edit 1 as the “process information management.” The storage unit 14 stores “wiring information status=normal” as the “object information” of the “post-edit information.” In the edit 1, wiring addition is performed on the net A, and added wiring is displayed on the CAD data under edit.

The storage unit 14 stores the edit 1 as the “command information management,” and the “edit information=part movement” related to the part B in the edit 1 as the “process information management.” The storage unit 14 stores the “part information status=deleted” as the “object information” of “pre-edit information,” and “part information status=normal” as the “object information” of “post-edit information.” In the edit 1, the part B is moved, and is displayed on the CAD data under edit. Since the “status” of the pre-edit information is “deleted,” the data of the part B prior to the movement thereof is not displayed on the CAD data under edit, and the data of the part B subsequent to the movement is displayed on the CAD data under edit.

The edit processes are not necessarily consecutively performed. For example, the CAD data under edit may be stored after the edit 1 is executed. The file is then reopened to execute the edit 2. The edit results on the CAD data remain unchanged from the consecutive operations of the edit 1 and the edit 2. The edit 1 and the edit 2 are managed under the same “undo information.”

Returning to FIG. 1, the controller 15 may be an integrated circuit such as an application specific integrated circuit (ASIC), a central processing unit (CPU), or a micro processing unit (MPU). The controller 15 includes an internal memory storing a control program such as an operating system (OS), a program defining a variety of processes, and specific data. The controller 15, further includes an edit executor 16, and an undo executor 17 that executes a variety of processes.

The edit executor 16 edits data, and then stores on the storage unit 14 the executed edit content as the undo information. For example, via the input unit 12, the edit executor 16 receives an edit content such as wiring addition or part movement to the CAD data as an edit target on the editing apparatus 10. The edit executor 16 then executes the received edit content on the CAD data and stores the executed content on the storage unit 14.

For example, the edit executor 16 may receive edit X to execute the movement of a part X subsequent to the edit 4 illustrated in FIG. 2. In this case, the edit executor 16 moves the part X on the CAD data as an edit target to a location specified by a user via the input unit 12. The edit executor 16 adds “edit X” as the “command information management” of the “undo information” of the CAD data stored on the storage unit 14. The edit executor 16 further adds “process information management, edit information=part movement” to the added “command information management=edit X.” The edit executor 16 further adds “part information, status=deleted” to the “pre-edit information” of the added “process information management, edit information=part movement, and adds “part information, status=normal” to the “post-edit information.” An actually executed process content, such as the direction and distance of movement of the part X, may be stored with the “command information management” mapped thereto. The editing apparatus 10 thus displays the part X, newly moved in “edit X”, on the CAD data under edit on the display 13.

If a further edit process is executed on the information already stored on the storage unit 14, the edit executor 16 may update the already stored “process information management” rather than newly adding the “process information management.” For example, the part B managed in the “process information management” of the net A illustrated in FIG. 3 may be further moved in an executed edit process. The edit executor 16 then modifies the “part information status” of the “pre-edit information” in the “process information management” of the part B illustrated in FIG. 3 to “deleted,” and modifies the “part information status” of the “post-edit information” to “normal.” The edit executor 16 then adds “edit X” as the “command information management” of the “undo information” in the CAD data stored on the storage unit 14. The edit executor 16 then manages the “command information management” of the added “edit X” and the modified “process information management” of the part B in a mapped state. Since the edit information is managed without the need to produce new information, the memory capacity of the storage unit 14 may be reduced.

The undo executor 17 includes target determiner 17a, information controller 17b, executor 17c, and information adder 17d. When revisions to the CAD data performed during an edit process is undone, information immediately preceding the updated undo information stored on the storage unit 14 may indicate an edit content. In such a case, the undo executor 17 undoes (restores) the data to a state prior to the execution of the edit content. If information immediately preceding the updated undo information stored on the storage unit 14 indicates an undo content, the undo executor 17 undoes (restores) the data to a state prior to the execution of the undo content. The undo executor 17 then stores thus undone content onto the storage unit 14 as undo information.

The target determiner 17a receives an undo process start instruction and a process target via the input unit 12, and determines a target to be undone. Upon receiving the undo process start instruction via the input unit 12, the target determiner 17a outputs the undo process start instruction to the information controller 17b. Upon receiving information about the net A or the part B as a process target together with the undo process start instruction via the input unit 12, the target determiner 17a outputs to the information controller 17b the received information about the net A or the part B as the process target.

Upon receiving the undo process start instruction from the target determiner 17a, the information controller 17b reads the information immediately preceding the updated undo information stored on the storage unit 14 and then outputs the read information to the executor 17c. Upon receiving the undo process start instruction and the process target from the target determiner 17a, the information controller 17b reads the latest executed undo information out of the execution information related to the process targets stored on the storage unit 14 and outputs the read undo information to the executor 17c.

The executor 17c executes the undo information received from the information controller 17b. If the undo information received from the information controller 17b is an edit content, the executor 17c undoes the data to a state prior to the execution of the edit content. If the undo information received from the information controller 17b is an undo content, the executor 17c undoes the data to a state prior to the execution of the undo content. The executor 17c then outputs the executed undo content to the information adder 17d.

The information adder 17d stores on the storage unit 14 the undo content from the executor 17c as redo information that is to be used to perform a process on the data that has been undone through an undo process.

The information adder 17d stores the undo content as the updated undo information on the storage unit 14.

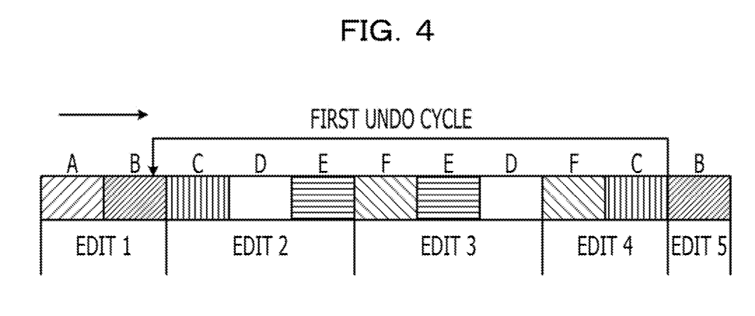

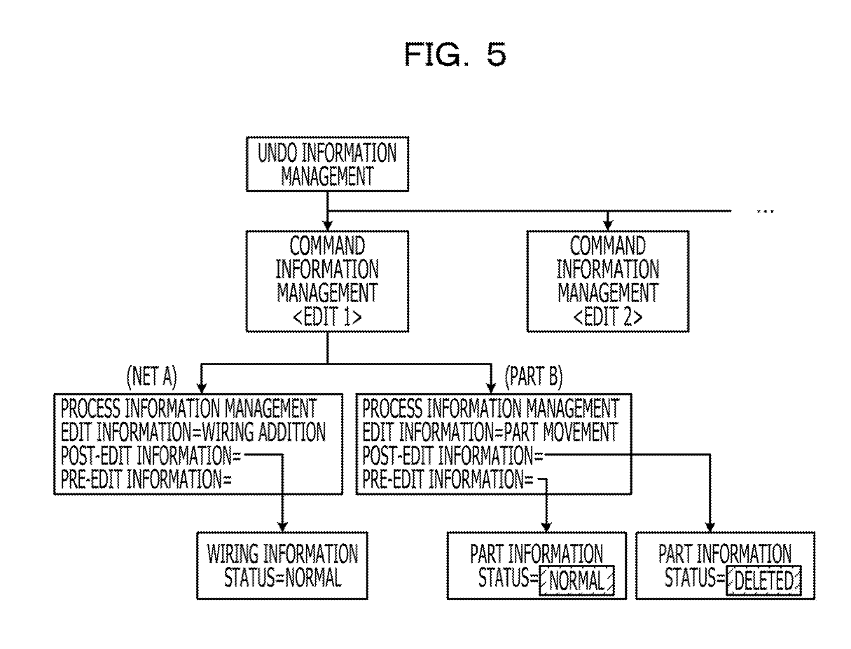

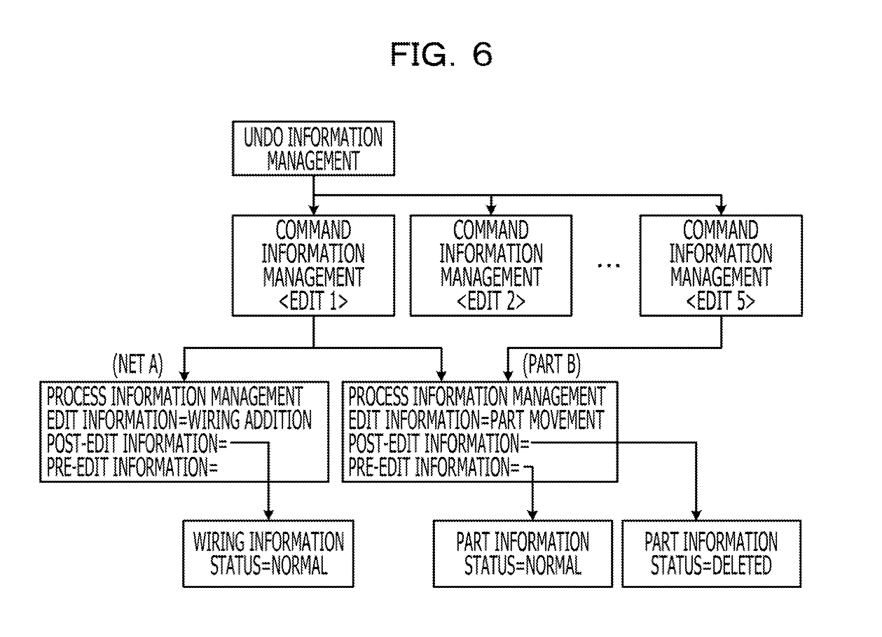

A process of storing the redo information on the storage unit 14 with the data undone, and a change in the execution information to be stored on the storage unit 14 are described below with reference to FIGS. 4-6. FIG. 4 illustrates a process example in which a new undo process is performed. FIG. 5 illustrates a process example in which information on the storage unit 14 is modified in response to the executed undo process. FIG. 6 illustrates a process example in which the executed undo process is stored on the storage unit 14 as the redo information.

Referring to FIG. 4, edit 1, edit 2, edit 3, and edit 4 have been performed on a file as an edit target in that order. In the edit 1, net A is edited, and part B is edited. In the edit 2, net C is edited, net D is edited, and part E is edited. In the edit 3, net F is edited, part E is edited, and net D is edited. In the edit 4, net F is edited and net C is edited. As illustrated in FIG. 4, different from FIG. 2, the edit 4 is followed by edit 5.

The content executed in the edit 5 may be “an undo process to undo the part B back to the original state.” In such a case, the target determiner 17a determines the part B as an undo target, and outputs to the information controller 17b the undo process start instruction and the part B as the undo target. The information controller 17b reads from the storage unit 14 the process information management “part movement” of the command information management “edit 1” as the undo information executed latest out of the undo information related to the part B. The information controller 17b then outputs the process information management “part movement” to the executor 17c. The information controller 17b also reads the edit content mapped to the process information management “part movement” and then outputs the read edit content to the executor 17c.

The executor 17c executes an undo process by reversing the process information management “part movement” of the received command information management “edit 1.” More specifically, the executor 17c reverses the movement of the part B caused in response to the process information management “part movement” of the “edit 1” back to the original state of the part B.

Referring to FIG. 5, the information adder 17d modifies the “status” of the “post-edit information” in the process information management “part movement” from “normal” to “deleted,” and the “status” of the “pre-edit information” from “deleted” to “normal.” More specifically, the information adder 17d deselects the part B from displaying by modifying to “deleted” the post-edit status of the part B moved in the edit 1 and selects the part B for displaying by modifying to “normal” the pre-edit status of the part B moved in the edit 1. The information adder 17d stores the undo content executed by the executor 17c with the process information management “part movement” mapped thereto. As a result, a reverse process to the edit 1, namely, an undo process is performed.

The information adder 17d adds the edit 5 as new “command information management” as illustrated in FIG. 6. The “process information management” of the part B, on which the executor 17c has executed the undo process, is mapped to the “command information management.” The undo content, i.e., redo information is thus managed without producing new “process information management” on the storage unit 14.

Process Flow of Editing Apparatus

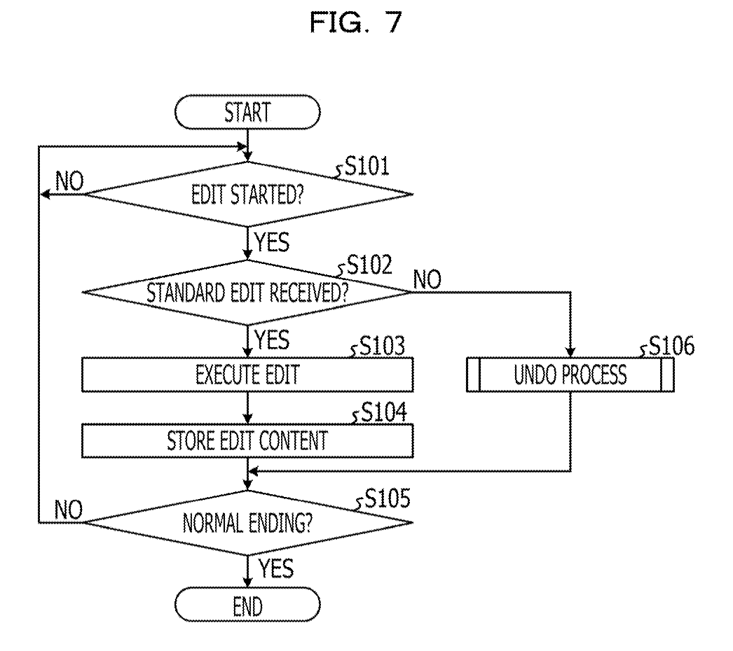

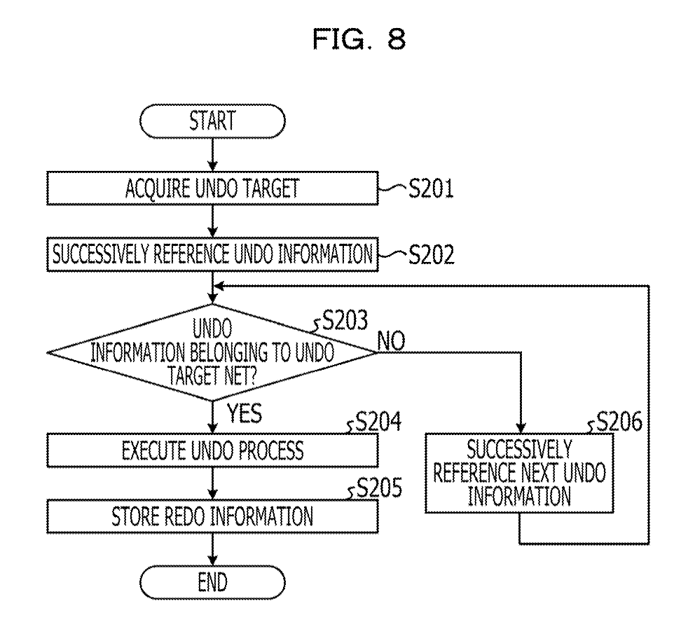

A process flow of the editing apparatus 10 is described below with reference to FIGS. 7 and 8. The general process flow of the editing apparatus 10 is described with reference to FIG. 7, and the undo process is described with reference to FIG. 8.

General Process Flow

FIG. 7 is a flowchart illustrating the process flow of the editing apparatus 10 of the first embodiment. As illustrated in FIG. 7, the controller 15 in the editing apparatus 10 receives an edit start instruction via the input unit 12 (yes branch from operation S101). The controller 15 then reads target CAD data and starts editing the CAD data. The controller 15 determines whether a standard edit content has been received (operation S102).

If a standard edit content has been received (yes branch from operation S102), the edit executor 16 executes the edit content instructed via the input unit 12 (operation S103). The edit executor 16 stores the executed edit content as undo information on the storage unit 14 (operation S104). The edit executor 16 then returns to operation S101 and subsequent operations until an edit process end instruction has been received via the input unit 12 (no branch from operation S105). Upon receiving an edit process end instruction via the input unit 12, the edit executor 16 ends the process (yes branch from operation 105).

If a content other than the standard edit content, i.e., an undo content, is received in operation S102 (no branch from operation S102), the undo executor 17 acquires an undo process target from the information input via the input unit 12, and performs the undo process (operation S106), and then performs operation S105.

Undo Process Flow

FIG. 8 is a flowchart of the undo process. The process of FIG. 8 is the process performed in operation S106 of FIG. 7. Referring to FIG. 8, the target determiner 17a acquires the undo process target from the information input via the input unit 12 and determines the target (operation S201).

The information controller 17b successively references the undo information (execution information) corresponding to the undo process target (operation S202), and then determines whether the referenced undo information belongs to a process target net (operation S203).

If it is determined that the undo information referenced by the information controller 17b belongs to a process target net (yes branch from operation S203), the executor 17c executes the undo process in response to the referenced undo information (operation S204). The information adder 17d then stores the information related to the undo process executed by the executor 17c onto the storage unit 14 as the redo information (operation S205).

If it is determined in operation S203 that the referenced undo information does not belong to the process target net (no branch from operation S203), the information controller 17b reads next information from the storage unit 14 and then performs the process in operation S203 (operation S206).

Management Method of Undo Information on a Per Process Target Location Basis

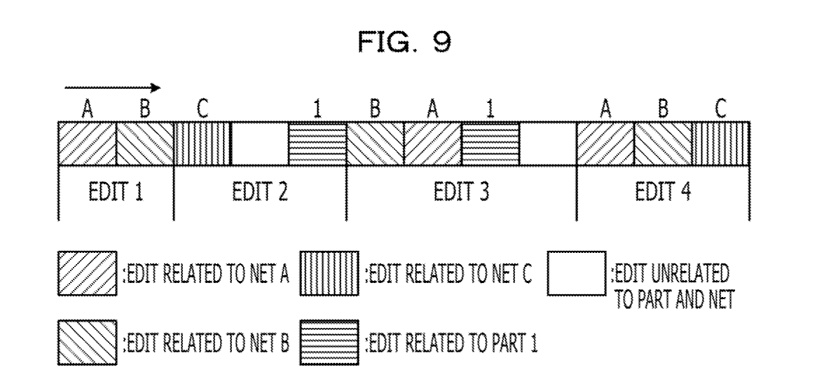

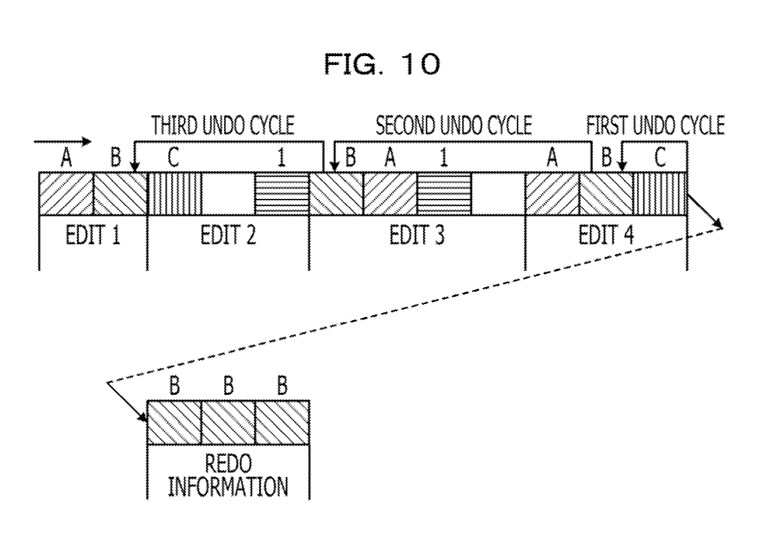

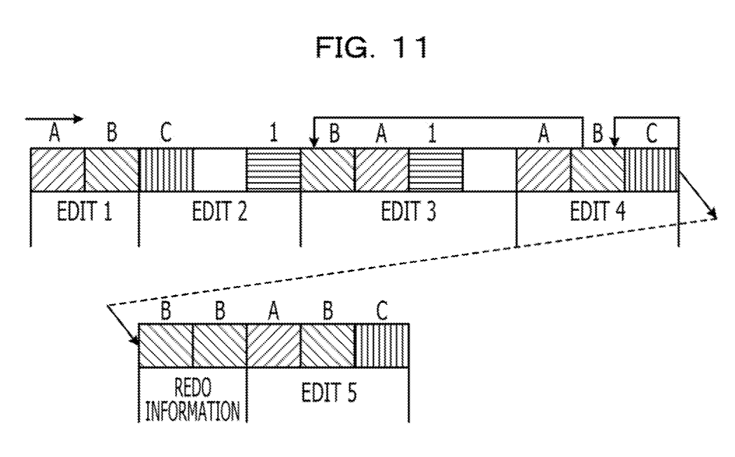

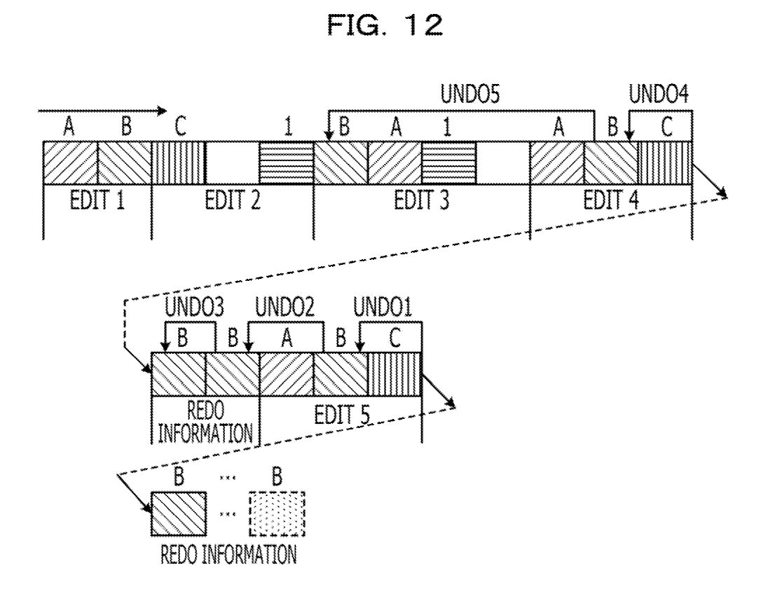

A management method of the undo information on a per process target location basis is described with reference to FIGS. 9-12. The process target location may be a net unit, for example. FIG. 9 illustrates a history example of the executed edit information. FIG. 10 illustrates the undo content resulting from undoing and stored as the redo information. FIG. 11 illustrates an edit process that resumes subsequent to the undo process. FIG. 12 illustrates an undo process that is performed after the resumption of the edit process of FIG. 12.

As illustrated in FIG. 9, the edit 1, the edit 2, the edit 3, and the edit 4 have successively been executed on the CAD data as an edit target in that order. Executed in the edit 1 are an edit process related to the net A and an edit process related to the net B. Executed in the edit 2 are an edit process related to the net C and an edit process unrelated to part and net. Executed in the edit 3 are an edit process related to the net B, an edit process related to the net A, an edit process related to the part 1, and an edit process unrelated to part and net. Executed in the edit 4 are an edit process related to the net A, an edit process related to the part B, and an edit process related to the net C.

The undo executor 17 in the editing apparatus 10 may now execute three undo processes consecutively for only the net B in response to an operation input entered by a user. As illustrated in FIG. 10, the undo executor 17 successively traces back the edit starting with the edit 4 as the updated edit information stored on the storage unit 14, and undoes only information related to the net B. More specifically, the undo executor 17 undoes the edit 4 related to the net B as a first undo cycle, undoes the edit 3 related to the net B as a second undo cycle, and undoes the edit 2 related to the net B as a third undo cycle. As illustrated in FIG. 10, the undo executor 17 stores the undo content, executed in the first, second, and third undo cycles, on the storage unit 14, in succession to the edit 4 as the redo information.

The edit 5 may resume in the edit state illustrated in FIG. 9 after the undo process has been repeated twice consecutively on the net B only. In such a case, as illustrated in FIG. 11, the undo executor 17 successively traces back the edit starting with the edit 4 as the updated edit information stored on the storage unit 14, and undoes only information related to the net B. The undo executor 17 undoes the edit 4 related to the net B as a first undo cycle, and undoes the edit 3 related to the net B as a second undo cycle. As illustrated in FIG. 11, the undo executor 17 stores the undo content, executed in the first, and second undo cycles, on the storage unit 14, in succession to the edit 4 as the redo information. In succession to the redo information, the edit executor 16 stores on the storage unit 14 the edit content related to the net A, the edit content related to the net B, and the edit content related to the net C in that time-series order as detailed information of the newly executed edit 5.

With the edit 5 executed in FIG. 11, the user may operate the undo process consecutively five cycles on the net B only. As illustrated in FIG. 12, the undo executor 17 successively traces back the edit starting with the edit 5 as the updated edit information stored on the storage unit 14, and undoes only information related to the net B. More specifically, the undo executor 17 undoes the edit 5 related to the net B as a first undo cycle, undoes a process of the redo information related to the net B as a second undo cycle, and undoes a process of the redo information related to the net B as a third undo cycle. The undo executor 17 undoes a process related to the net B in the edit 4 as a fourth undo cycle, and undoes a process related to the net B in the edit 3 as a fifth undo cycle. The undo executor 17 then stores the undo information, executed in each of the first through fifth undo cycles, on the storage unit 14 in succession to the edit 5 in the time-series order.

Specific Examples of Edit and Undo Process

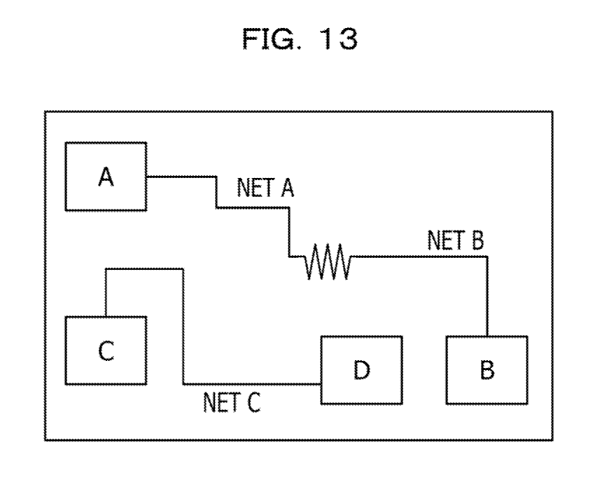

Specific examples of edit and undo process are described below with reference to FIGS. 13-22. As illustrated in FIG. 13, an active part A is connected to an active part B via a resistor and wiring of a net A and a net B on an electrical wiring board. An active part C is connected to an active part D via wiring of a net C on the electrical wiring board. The electrical wiring board is now edited.

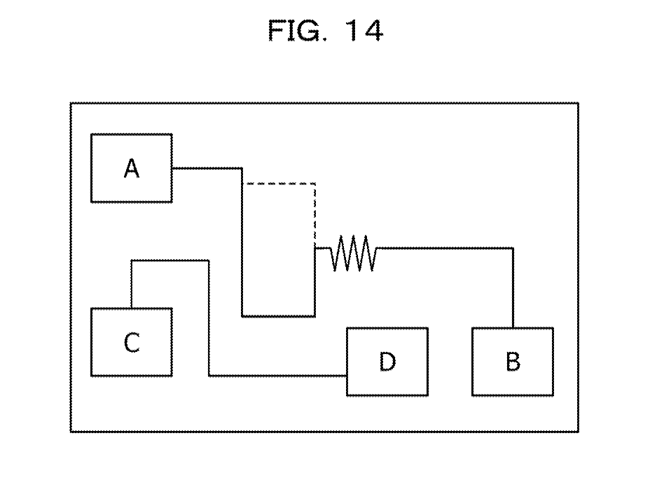

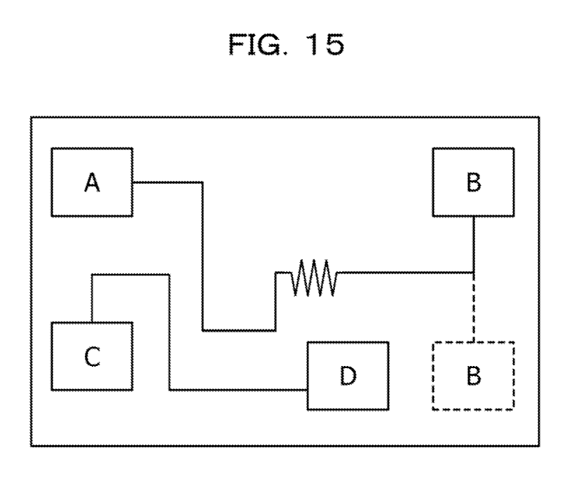

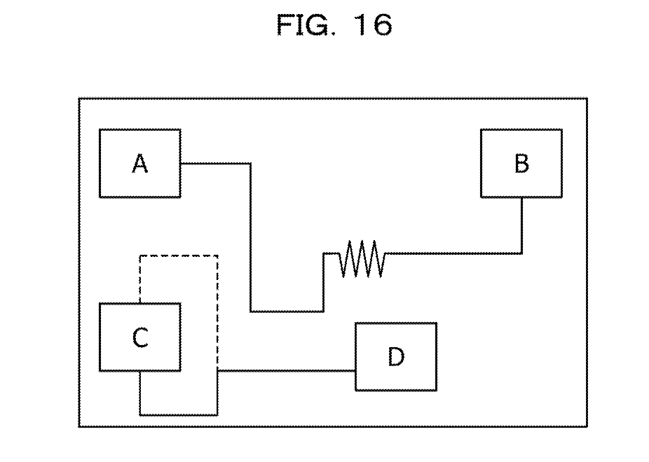

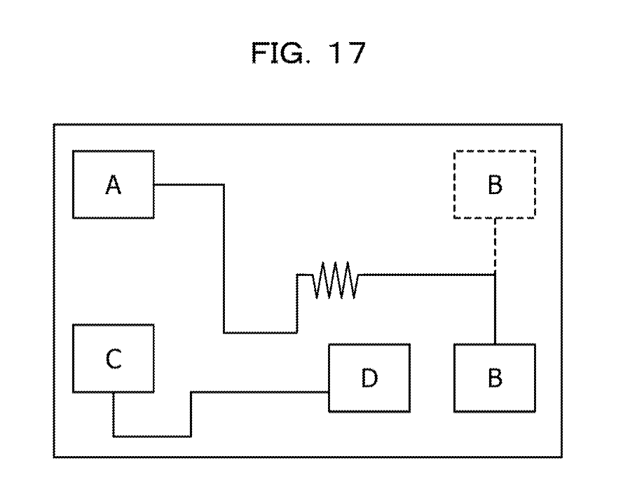

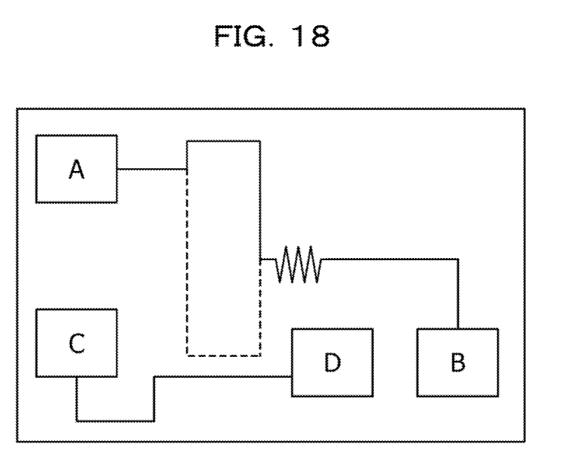

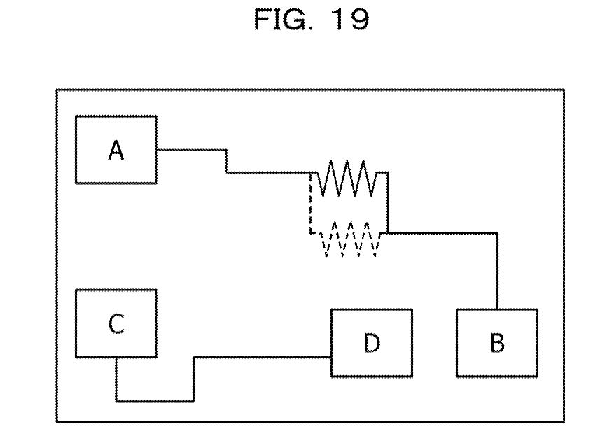

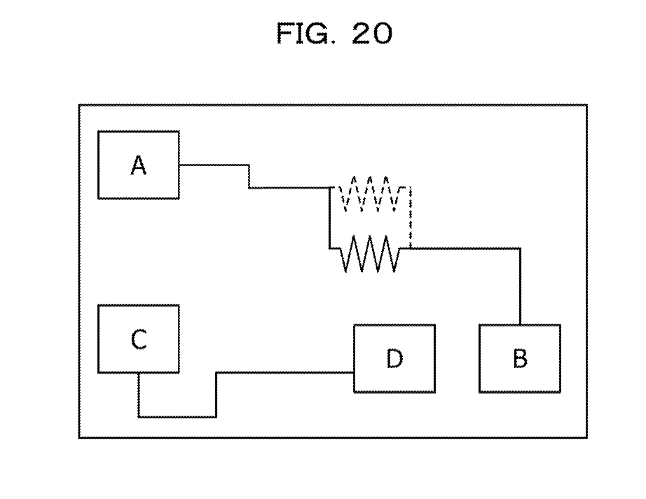

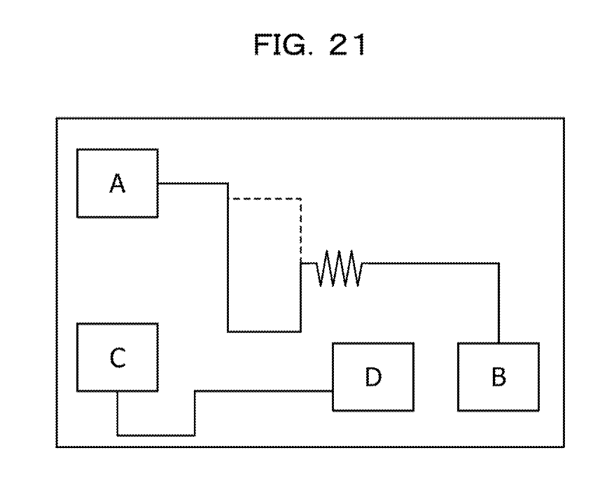

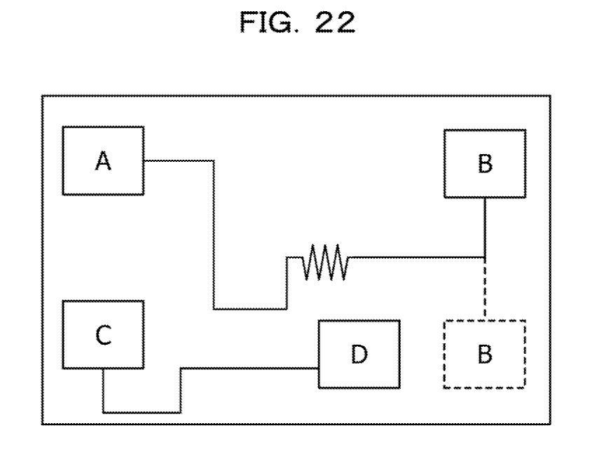

FIG. 13 illustrates an example of the electrical wiring board as an edit target, FIG. 14 illustrates a process example in which the wiring design of the active parts A and B (net A) on the electrical wiring board of FIG. 13 is edited, and FIG. 15 illustrates a process example in which the wiring design of the active parts A and B (net B) on the electrical wiring board of FIG. 14 is edited. FIG. 16 illustrates a process example in which the wiring design of the active parts C and D (net C) on the electrical wiring board of FIG. 15 is edited. FIG. 17 illustrates a process example in which the undo process is executed on the net A on the electrical wiring board of FIG. 16. FIG. 18 illustrates a process example in which a second undo cycle is executed on the net A on the electrical wiring board of FIG. 17. FIG. 19 illustrates a process example in which the edit process resumes on the electrical wiring board of FIG. 18 and the design of the wiring between the active parts A and B (net A) is edited. FIG. 20 illustrates a process example in which the undo process is executed on the net A on the electrical wiring board of FIG. 19. FIG. 21 illustrates a process example in which a second undo cycle is executed on the net A on the electrical wiring board of FIG. 20. FIG. 22 illustrates a process example in which a third undo cycle is executed on the net A on the electrical wiring board of FIG. 21. It is noted that each of the net A and the net B is handled as a net unit.

Upon receiving an edit instruction via the input unit 12 from the user, the edit executor 16 modifies the wiring of the net A as illustrated in FIG. 14 and stores the modified edit content on the storage unit 14. The edit executor 16 then receives an edit instruction via the input unit 12 from the user, modifies the position of the part B as illustrated in FIG. 15, and stores the modified edit content on the storage unit 14. The edit executor 16 then receives an edit instruction via the input unit 12 from the user, modifies the wiring of the net C as illustrated in FIG. 16, and stores the modified edit content on the storage unit 14. At this point of time, the storage unit 14 stores the modified wiring of the net A, the modified position of the part B, and the modified wiring of the net C in that order as the undo information.

Upon receiving an undo instruction related to the part B via the input unit 12 from the user, the undo executor 17 reads the undo information related to the updated net A stored on the storage unit 14, i.e., the modified position of the part B related to the net A as illustrated in FIG. 15. The user may make an undo instruction by putting certain key of the keyboard, inputting certain command from the keyboard, pointing certain area on the display window by a mouse, for example. As illustrated in FIG. 17, the undo executor 17 undoes the position of the part B from the position of FIG. 15 to the position of FIG. 14, and stores the executed undo content onto the storage unit 14 as the redo information. At this point of time, the storage unit 14 stores the modified wiring of the net A, the modified position of the part B, the modified wiring of the net C, and the executed undo position information of the part B (redo information) in that order as the undo information.

Upon receiving an undo instruction related to the part A via the input unit 12 from the user, the undo executor 17 reads the undo information related to the updated net A stored on the storage unit 14, i.e., the modified wiring of the net A illustrated in FIG. 14. As illustrated in FIG. 18, the undo executor 17 undoes the wiring of the net A from the state of FIG. 14 to the state of FIG. 13, and stores the executed undo content onto the storage unit 14 as the redo information. At this point of time, the storage unit 14 stores the modified wiring of the net A, the modified position of the part B, the modified wiring of the net C, and the executed undo position information of the part B (redo information), and the executed undo wiring information of the net A (redo information) in that order as the undo information.

The edit executor 16 may now resume the edit process in the state of FIG. 18. Upon receiving an edit instruction via the input unit 12 from the user, the edit executor 16 modifies the wiring of the net A as illustrated in FIG. 19, and stores the modified edit content on the storage unit 14. At this point of time, the storage unit 14 stores the modified wiring of the net A, the modified position of the part B, the modified wiring of the net C, the executed undo position information of the part B (redo information), the executed undo wiring information of the net A (redo information), and the modified wiring of the net A in that order as the undo information.

The undo executor 17 receives an undo instruction related to the net A via the input unit 12 from the user, and reads the undo information of the updated net A stored on the storage unit 14, i.e., the modified wiring of the net A illustrated in FIG. 19. The undo executor 17 undoes the wiring of the net A from the state of FIG. 19 to the state of FIG. 18, and stores the executed undo content onto the storage unit 14 as the redo information.

The undo executor 17 receives an undo instruction related to the net A via the input unit 12 from the user, and reads the second latest undo information at the time point of FIG. 20, out of the undo information of the updated net A stored on the storage unit 14. More specifically, the undo executor 17 reads the wiring undo information of the net A executed in FIG. 18, and executes the wiring undo of the net A. As illustrated in FIG. 21, the undo executor 17 thus undoes the wiring of the net A from the state of FIG. 18 to the state of FIG. 14, and stores the executed undo content on the storage unit 14 as the redo information.

The undo executor 17 receives an undo instruction related to the net A via the input unit 12 from the user, and reads the third latest undo information at the time point of FIG. 20, out of the undo information of the updated net A stored on the storage unit 14. More specifically, the undo executor 17 reads the position undo information of the part B related to the net A executed in FIG. 17, and executes the position undo of the part B. As illustrated in FIG. 22, the undo executor 17 thus undoes the position of the part B from the state of FIG. 17 to the state of FIG. 15, and stores the executed undo content on the storage unit 14 as the redo information.

At the end of the process, the storage unit 14 stores the modified wiring of the net A, the modified position of the part B, the modified wiring of the net C, the position undo information of the part B (redo information), the wiring undo information of the net A (redo information), and the modified wiring of the net A in that order as the undo information. The storage unit 14 further stores the wiring undo information of the net A executed in FIG. 20 (redo information), the wiring undo information of the net A executed in FIG. 21 (redo information), and the position undo information of the part B executed in FIG. 22 (redo information) in that order. The undo information is mapped to detailed information, for example, of position to which the part has been moved, and of how the wiring has been modified.

### Advantages of the First Embodiment

According to the first embodiment, the information of the executed undo process is stored as the execution information on the storage unit 14, and is then processed as a target of an undo process. Even after data under edit is undone at any point of time, the undone data is then restored to the data prior to the undo process. More specifically, if the edit resumes after the data under edit is undone at any point of time, the undone data is restored back to the data prior to the undo process.

In the undo process, the editing apparatus 10 of the first embodiment manages the undo information on a per net unit basis and on a per part unit basis. The editing apparatus 10 may undo only a net or a part the user may intend the net or the part to be in the pre-edit state thereof. If the edit process resumes, the editing apparatus 10 stores a history prior to the undo process, and thus reverts back to the state prior to the undo process. The editing apparatus 10 of the first embodiment leaves intact a net that needs no undo process to the pre-edit state, and a re-edit process is not needed. The editing apparatus 10 of the first embodiment may thus revert back to a pre-undo state.

The technique discussed herein may be applied to an embodiment other than the embodiment discussed heretofore. Alternative embodiments are described below.

Edit Target Data

According to the first embodiment, the edit target data is the CAD data. The edit target data is not limited to the CAD data. The editing apparatus 10 discussed herein may process a variety of data such as data for a document production software program or data for a spreadsheet software program.

Storage Example of Storage Unit

In the first embodiment, the undo information (execution information) mapping the edit location or the undo location of the net A, for example, to the edit content or the undo content respectively is stored on the storage unit 14. The embodiments are not limited to this method. The editing apparatus 10 may store only the undo information (execution information) with the edit location and the undo location unmapped thereto. In such a case, the undo targets may follow the time-series order thereof according to which the undo information is stored on the storage unit 14. More specifically, the editing apparatus 10 undoes the latest edit content or the latest undo content in a first undo cycle. In a second undo cycle, the editing apparatus 10 restores information immediately prior to the latest edit content or the latest undo content. Alternatively, the storage unit 14 may store the undo content only rather than storing the edit content.

System Configuration

Each process discussed with reference to the first embodiment, part or whole of the process that is discussed as being automatically performed may be performed manually. Alternatively, part or whole of the process that is discussed as being manually performed, for example, the reception process of the process start instruction, may be performed automatically in a known method. The operation procedure, control procedure, and specific names of elements in the specification and the drawings, for example, information including a variety of data and parameters illustrated in FIGS. 3, 5, and 6, may be changed unless otherwise particularly noted.

The elements in each apparatus discussed above represent functional concepts thereof and are not necessarily physically arranged as illustrated. For example, the edit executor 16 and the undo executor 17 may be integrated into one unit. Each apparatus may be split or integrated, and the configuration of the elements thereof is not limited to the configuration illustrated in the drawings. Part or whole of the apparatus may be split or integrated functionally or physically on any unit depending on a variety of workload conditions and usage status. Part or whole of the function in each apparatus may be implemented through a CPU or a software program executed by the CPU, or may be implemented through hardware such as wired logic.

Software Program

The variety of processes discussed above may be performed by a computer system, including a personal computer or a workstation, which executes a pre-installed software program. An example of computer system that executes a program having the same function as the first embodiment is described below.

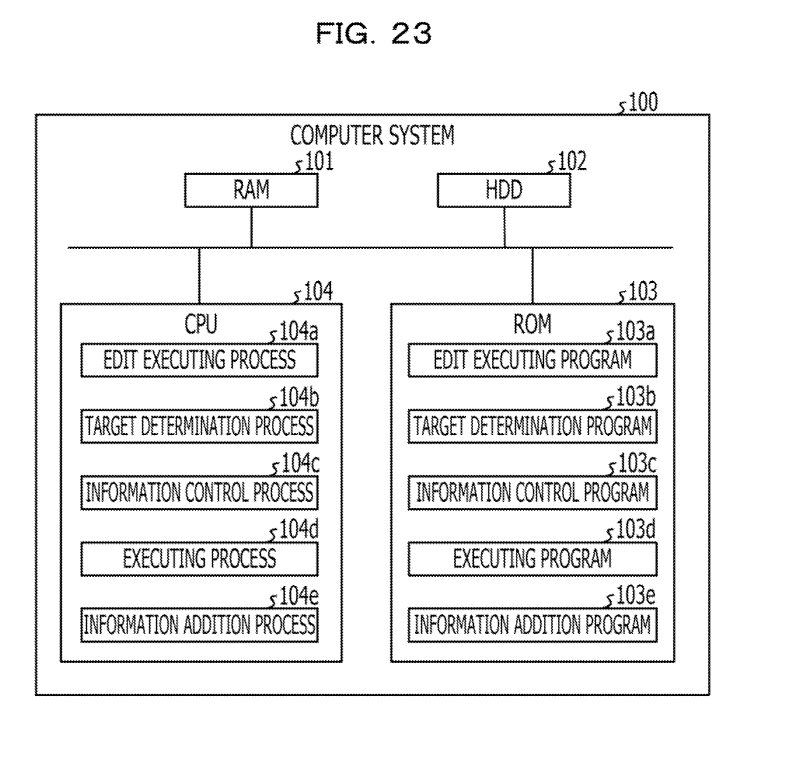

FIG. 23 illustrates an example of a computer system 100 executing an editing program. Referring to FIG. 23, the computer system 100 includes RAM 101, HDD 102, ROM 103, and CPU 104. The ROM 103 pre-stores the program having the same function as that of the embodiment. More specifically, the ROM 103 pre-stores edit executing program 103a, target determination program 103b, and information control program 103c. The ROM 103 further pre-stores executing program 103d and information addition program 103e.

The programs 103a-103e, when read and executed by the CPU 104, become virtual processes as illustrated in FIG. 23. More specifically, the programs 103a-103e become edit executing process 104a, target determination process 104b, information control process 104c, executing process 104d, and information addition process 104e, respectively. The edit executing process 104a corresponds to the edit executor 16 of FIG. 1, the target determination process 104b corresponds to the target determiner 17a, and the information control process 104c corresponds to the information controller 17b. The executing process 104d corresponds to the executor 17c, and the information addition process 104e corresponds to the information adder 17d.

The HDD 102 stores, as the undo information (execution information), the edit content indicating the content of edited data and the undo content indicating the undone data in the time-series order according which the edit process or the undo process has been performed. The HDD 102 thus corresponds to the storage unit 14 of FIG. 1.

The programs 103a-103e are not necessarily stored on the ROM 103. For example, the programs 103a-103e may be stored on one of “removable physical media” loaded onto the computer system 100, including a flexible disc (FD), a compact-disc ROM (CD-ROM), a digital versatile disc (DVD), a magneto-optical disc, and an IC card. The programs 103a-103e may be stored on a “fixed physical medium” such as a hard disk drive (HDD) internal to or external to the computer system 100. Alternatively, the programs 103a-103e may be stored on “another computer” that is connected to the computer system 100 via a public telephone line, the Internet, a local-area network, a wide-area network, or the like. The computer system 100 may read the program from these storage media and then execute the read program.

The program of the embodiment may be stored on the media such as “removable physical media,” the “fixed physical media,” and the “other computer” in a computer-readable fashion. The computer system 100 then reads the program from the storage media, and executes the read program. The computer system 100 thus performs the same function as the function of the embodiment. The program discussed in the alternative embodiment is not limited to the operation in which the program is executed by the computer system 100. For example, the invention may be equally applied to the operation in which the program is executed by the other computer system or a server, or the operation in which the other computer system and the server execute the program in cooperation with each other.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal. The media described above may be non-transitory media.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

1. An editing apparatus, comprising:
a storage unit to store, as execution information in a time-series order of edit or undo processes, an edit content indicating a content of edit of data and an undo content indicating a content of undo of the data;
an edit executor to edit the data and to store on the storage unit the edit content as the execution information; and
an undo executor to undo the data to a state prior to the execution of the edit content if the updated execution information stored on the storage unit indicates the edit content, or to undo the data to a state prior to the execution of the undo content if the updated execution information stored on the storage unit indicates the undo content, and to store as the execution information a content of the executed undo on the memory unit.

2. The editing apparatus according to claim 1, wherein the storage unit stores the execution information, the execution information mapping the edit content or the undo content to an edited location or an undone location, respectively; and
wherein the undo executor identifies updated execution information from the execution information on the storage unit corresponding to a target location of the undo, executes data undo in response to the identified execution information, and stores the executed undo content on the storage unit.

3. The editing apparatus according to claim 2, wherein if undo target locations are to be undone consecutively by a specific number of times, the undo executor identifies the execution information for the specific number of times of undo from the updated execution information corresponding to the locations and stored on the storage unit, undoes the undo target locations in order in accordance with the identified execution information, and stores as the execution information the undo content in the order of execution.

4. A method of editing executed by a computer, comprising:
modifying first data into second data by executing a first editing process on the first data;
modifying the second data into the first data by executing a first undo process subsequent to the execution of the first editing process;
storing undo information regarding the first undo process on a storage unit;
modifying the first data into third data by executing a second editing process subsequent to the execution of the first undo process;
modifying the third data into the first data by executing a second undo process subsequent to the execution of the second editing process; and
modifying the first data into the second data by executing a third undo process in accordance with the undo information of the first undo process stored on the storage unit subsequent to the second undo process.

5. A non-transitory computer-readable medium for recording an editing program allowing a computer to execute:
modifying first data into second data by executing a first editing process on the first data;
modifying the second data into the first data by executing a first undo process subsequent to the execution of the first editing process;
storing undo information regarding the first undo process on a storage unit;
modifying the first data into third data by executing a second editing process subsequent to the execution of the first undo process;
modifying the third data into the first data by executing a second undo process subsequent to the execution of the second editing process; and
modifying the first data into the second data by executing a third undo process in accordance with the undo information of the first undo process stored on the storage unit subsequent to the second undo process.
